(19) United States
(12) Patent Application Publication
(10) Pub. No.: US 2018/0061361 A1
(43) Pub. Date: Mar. 1, 2018

(54) MANAGING DISPLAY SETTING BASED ON MOTION SENSOR ACTIVITY FOR UNIVERSAL PLATFORM APPLICATIONS

(71) Applicant: MICROSOFT TECHNOLOGY LICENSING, LLC, Redmond, WA (US)

(72) Inventors: Kishore Kumar Peshkar, Redmond, WA (US); David Tse, Redmond, WA (US)

(73) Assignee: MICROSOFT TECHNOLOGY LICENSING, LLC, Redmond, WA (US)

(21) Appl. No.: 15/367,004

(22) Filed: Dec. 1, 2016

Related U.S. Application Data
(60) Provisional application No. 62/380,975, filed on Aug. 29, 2016.

(51) Int. Cl. G09G 5/00; G06F 3/14; H04L 29/08; H04L 29/06

(52) U.S. Cl. CPC G09G 5/003; G06F 3/1454; H04L 67/10; G09G 2330/026; G09G 2354/00; G09G 2330/027; H04L 65/403

(57) ABSTRACT

Technologies may be provided for managing display settings based on motion sensor activity for universal platform applications. An example method may include registering an activity from a sensor indicating a need to activate a display at a universal platform meeting management application in a meeting room, activating a desktop application configured to manage the display from the universal platform meeting management application, and enabling the desktop application to activate the display. The desktop application may be included in a universal platform meeting management application package together with the universal platform meeting management application.

### CROSS-REFERENCE TO RELATED APPLICATION

This Application claims priority under 35 U.S.C. §119(e) to U.S. Provisional Patent Application Ser. No. 62/380,975 filed on Aug. 29, 2016. The disclosure of the U.S. Provisional Patent Application is hereby incorporated by reference in its entirety.

### BACKGROUND

Conference rooms may include a projection display or a similar display device for displaying content, projecting online meeting content, and executing other collaborative efforts. Conventional conference room displays may be controlled by a dedicated computer or by a meeting attendant's computing device. As such, display management may be performed through the display management programs in individual computers.

Modern conference rooms are equipped with enhanced devices to accommodate the increasingly complex needs of physical messages and online meetings, collaboration applications, online content, and additional functionality that users have come to expect. Thus, meeting management applications may coordinate various functionalities associated with meeting room operations. Such applications may need to have an active display available whenever people are present within a conference room to provide a satisfactory user experience. However, meeting management applications may deactivate due to software, hardware, or network issues, which may result in a degraded user experience, as this may force meeting attendants in the conference room to manually activate the systems.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to management of display settings based on motion sensor activity for universal platform applications. An example method according to embodiments may include registering an activity from a sensor indicating a need to activate a display at a universal platform meeting management application in a meeting room, activating a desktop application configured to manage the display from the universal platform meeting management application, and enabling the desktop application to activate the display. The desktop application may be included in a universal platform meeting management application package together with the universal platform meeting management application.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example schematic diagram of an example process to manage display settings based on motion sensor activity for universal platform applications;

FIG. 2 illustrates an example schematic diagram illustrating use of a universal platform meeting management application to manage display settings based on motion sensor activity within a meeting room;

FIG. 3 illustrates a conceptual diagram of an example process to manage display settings based on motion sensor activity for universal platform applications;

FIG. 4 is a networked environment, where a system according to embodiments may be implemented;

FIG. 5 is a block diagram of an example general purpose computing device, which may be used to manage display settings based on motion sensor activity for universal platform applications; and

FIG. 6 includes a logic flow diagram that illustrates a process to manage display settings based on motion sensor activity for universal platform applications, according to at least some embodiments disclosed herein.

### DETAILED DESCRIPTION

As briefly described above, embodiments may be provided to manage display settings based on motion sensor activity for universal platform applications. An example method may include registering an activity from a sensor indicating a need to activate a display at a universal platform meeting management application in a meeting room, activating a desktop application configured to manage the display from the universal platform meeting management application, and enabling the desktop application to activate the display based on detected sensor activity. The desktop application may be included in a universal platform meeting management application package together with the universal platform meeting management application.

According to further examples, in response to a detection, by the sensor, of the display exceeding a predefined period of inactivity, the method may additionally include turning off the display. In some examples, the method may additionally include detecting another activity from the sensor in the meeting room and enabling the desktop application to activate the display. In some examples, the other activity may include a participant entering the meeting room or a scheduled meeting being about to start. In an example scenario, a participant may schedule a meeting at 10.00 am in a particular meeting room. The desktop application executed on the meeting management device of the meeting room may detect the meeting being 5 minutes (or any other predefined time period) away from starting and activate the display such that when the participant enters the room, the display(s) is(are) ready. In further examples, the sensors may include one or more of: motion sensors, heat sensors, pressure sensors, and mechanical sensors. In some examples, the mechanical sensors may be further configured to detect one or more of: an opening of a door to the meeting room, a closing of the door to the meeting room, the opening of a window to the meeting room, and the closing of the window to the meeting room.

A universal platform application, as used herein, refers to an application that is part of a platform-homogeneous application architecture. Thus, a universal platform application may be executed on a number of operating systems, operating system versions, and/or devices without a need for customization or different versions of the application. For example, the same universal platform application may be installed/executed on a desktop platform and a mobile platform. Some universal platform applications may not indicate having been written for a specific operating system or platform in their manifest build; instead, they may target one or more device families, such as a PC, smartphone, tablet, or gaming systems. These extensions may allow the application to automatically utilize the capabilities that are available to the particular device it is currently running on. The platform-agnostic nature of these applications may allow enhanced user experience aspects in addition to efficiency and reduced complexity. For example, a universal platform application executed on a smartphone may start behaving the way it would if it were running on a PC when the smartphone is connected to a desktop computer or a suitable docking station. On the other hand, being platform agnostic may mean for some of these applications limitations over platform-specific applications. For example, a number and type of Application Programming Interfaces (APIs) available in the application may be limited. Thus, a functionality of a universal platform application may also be subject to constraints based on its design such as the ability re-launch itself upon crashing or experiencing an unintentional exit.

Compared to universal platform applications, desktop applications, as referred to herein, are typically platform-specific such as operating system, operating system version, device, etc. While their specificity may make it more difficult to manage desktop applications on different devices or operating systems, it may also provide them with a higher degree of freedom with respect to functionality. Operating system or device specific APIs may be provided in desktop applications, for example. Thus, desktop applications may lend themselves more toward certain functionality. For example, functionality that is associated with monitoring and reacting to events that happen at operating system or hardware level. Following the example provided above, a desktop application may be configured to re-launch itself upon a crash or unintentional exit.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can, for example, be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for interrupting a synchronization of content between a client device and a cloud-based storage service. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

The technical advantages of managing display settings based on motion sensor activity for universal platform applications may include, among others, improved computing device performance, reduced processing and network bandwidth usage associated with a computing device, energy savings associated with the computing device, and improved user interaction by allowing users to locate an active meeting management user interface at all times in a meeting room without having to launch or re-launch the systems.

Embodiments address a need that arises from very large scale of operations created by networked computing and cloud based services that cannot be managed by humans. The actions/operations described herein are not a mere use of a computer, but address results of a system that is a direct consequence of software used as a service such as communication services offered in conjunction with communications.

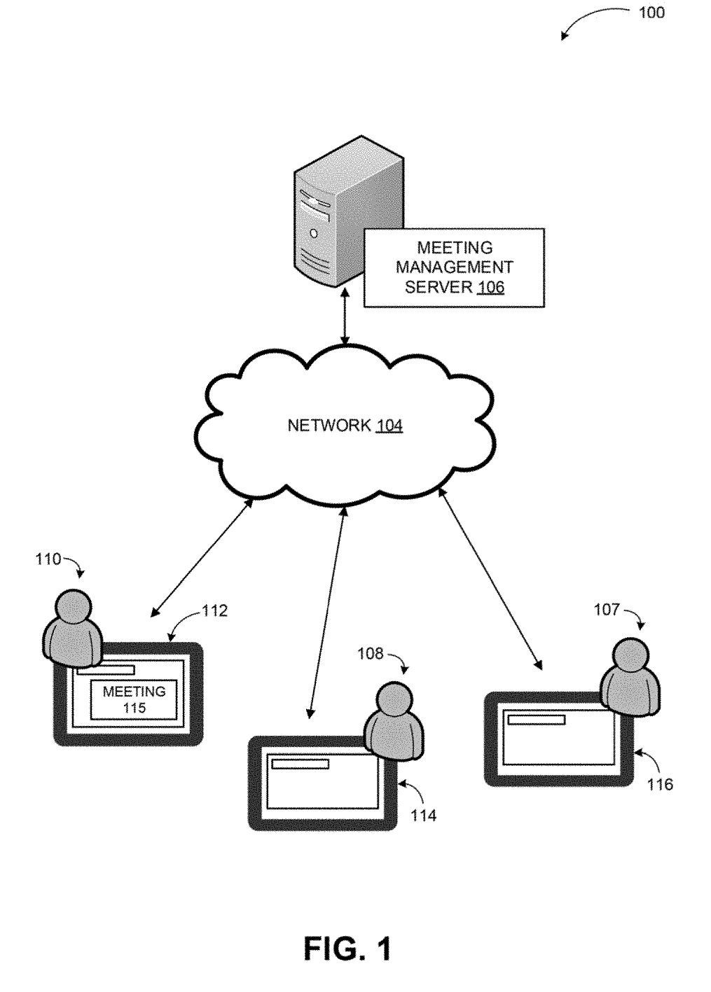

FIG. 1 illustrates an example schematic diagram of an example process to manage display settings based on motion sensor activity for universal platform applications, according to at least some embodiments disclosed herein.

As illustrated in a diagram 100, an example system may include a meeting management server 106. In some examples, the meeting management server 106 may be configured to interoperate with various applications to synchronize content stored in local storage on client devices (e.g., a first computing device 112, a second computing device 114, and/or a third computing device 116) with the same content stored remotely at the meeting management server 106. The first computing device 112 may be associated with a first participant 110. The second computing device 114 may be associated with a second participant 108. The third computing device 116 may be associated with a third participant.

In some examples, the first participant 110 may execute a thin version (e.g., a web browser) of an application through the first computing device 112, the second participant 108 may execute the thin version of the application through the second computing device 114, and/or the third participant 107 may execute the thin version of the application through a third computing device 116. According to some examples, a participant interface may facilitate communication over a network 104 and between the meeting management server 106 and the application.

The first computing device 112, the second computing device 114, and the third computing device 116 may be a desktop computer, a laptop computer, a tablet computer, a smart phone, a vehicle mount computer, or a wearable computer, among other devices. According to further examples, the first participant 110, the second participant 108, and/or the third participant 107 may execute a thick version (e.g., a locally-installed version) of the application through the first computing device 112, the second computing device 114, and/or the third computing device 116, respectively.

According to other examples, the application may be hosted by a meeting management service and the meeting management service may be configured to interact with the application over a network 104. The network 104 may comprise any topology of servers, clients, Internet service providers, and communication media. In some examples, the application may be a productivity application. The productivity application may include a word-processing application, a spreadsheet application, a presentation application, or a notebook application, among other examples. The participant interface may facilitate communication over the network 104 and between the meeting management service and the application. In some examples, the meeting management service may store data associated with a meeting 115 in a data store directly or through a database server.

As discussed above, a universal platform application may be suspended on a system with power settings set to “Sleep Never” or “Screen Off” after a predefined period of time, for example. In platform specific (desktop) applications, certain predefined functions may be defined to enable an application to inform the system that it is in use, thereby preventing the system from entering sleep mode or turning off the display while the application is running. An example such functions is the SetThreadExecutionState function used in Windows® applications by MICROSOFT CORPORATION of Redmond, Wash. The system may automatically detect activities such as local keyboard or mouse input, server activity, or changing user interface focus, for example. Activities that are not automatically detected may include disk or CPU activity and video display. By calling SetThreadExecutionState or similar function, the desktop application may reset an idle timer. In some examples, to keep the display or system in the working state, the desktop application may call SetThreadExecutionState periodically.

As the universal platform application cannot call a platform specific function such as SetThreadExecutionState, the desktop application may perform that task on behalf of the universal platform application notifying the system that the application is busy and preventing the system from entering sleep mode or turning off the display while the application is running.

To maintain the time since the last user input or similar activity, an operating system may use a display idle timer and a system idle timer. The system may compare the idle timers to the values configured in the power plan. If the display idle timer value is greater than the display time-out value, and no threads have requested the display by calling SetThreadExecutionState (for example with an ES_DISPLAY_REQUIRED parameter), the system may power off the display. Similarly, if the system idle timer is greater than the system time-out value and no applications have requested the system by calling SetThreadExecutionState (for example, with ES_SYSTEM_REQUIRED, the system may enter sleep.

In yet other examples, the universal platform application may be enabled to execute with or without display by the desktop application requesting ExtendedExecutionForegroundSession during the launch, for example. The ExtendedExecutionForegroundSession may support managing a request for extended foreground execution (for the universal platform application).

While the example system in FIG. 1 has been described with specific components including the meeting management server 106, the network 104, the first participant 110, the second participant 108, the third participant 107, the first computing device 112, the second computing device 114, and the third computing device 116, embodiments are not limited to these components or system configurations and can be implemented with other system configuration employing fewer or additional components.

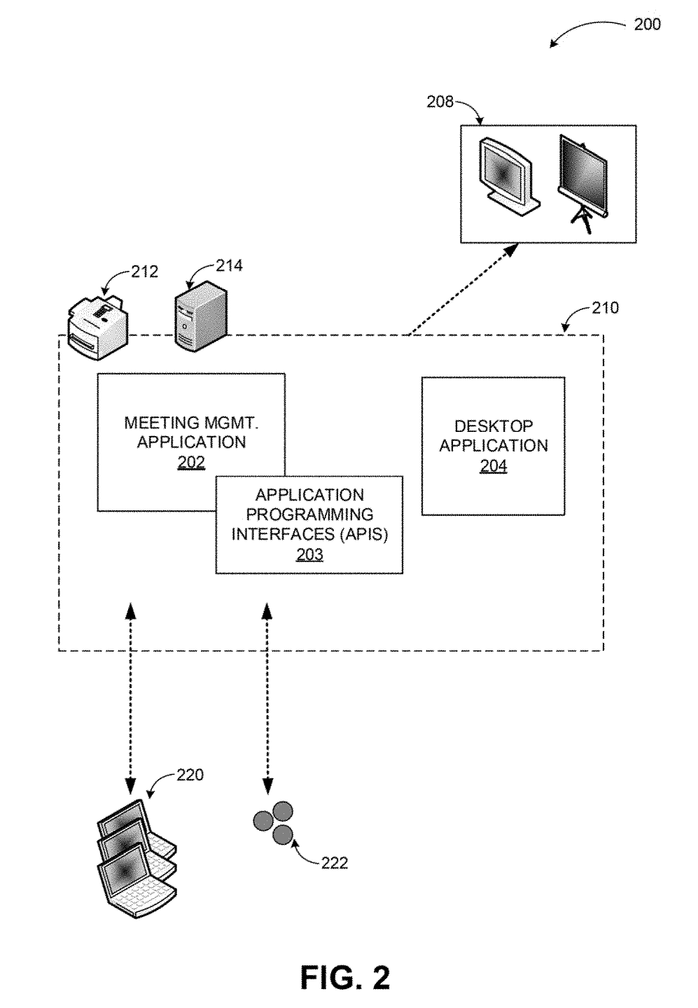

FIG. 2 illustrates an example schematic diagram illustrating use of a universal platform meeting management application to manage display settings based on motion sensor activity within a meeting room, according to at least some embodiments disclosed herein.

A diagram 200 may illustrate an example system. The example system may include a computing device 212. The computing device 212 may be configured to manage display settings based on motion sensor activity for universal platform applications. In some examples, the universal platform applications may be executed on any computing device (e.g., the computing device 212 or a select computing device of the other computing devices 220) and any software platform. As such, the universal platform applications may be subject to constraints associated with the software platform the universal platform applications are executed on.

The computing device 212 may include a communication interface, one or more sensors 222, a memory, and/or a processor, among other components. The communication interface may be configured to facilitate exchange of data with the other computing devices 220. The one or more sensors 222 may be configured to detect an activity within a meeting room. The memory may be configured to store instructions. The processor may be coupled to the communication interface, the one or more sensors 222, and/or the memory.

According to some examples, the processor may include a universal platform meeting management application 202. The universal platform meeting management application 202 may be configured to register the activity from the one or more sensors 222 during launch. The activity within the meeting room may include movement of participants and/or speech by the participants, among other activities. The movement by the participants may include one or more of the participants executing actions, such as, opening a door to the meeting room, closing the door to the meeting room, opening a window of the meeting room, and/or closing the window of the meeting room, etc.

In response to the universal platform meeting management application 202 registering the activity from the one or more sensors 222, a need to activate a display 208 in the meeting room may be indicated. The universal platform meeting management application 202 may be further configured to activate a desktop application 204 configured to manage the display 208 and may enable the desktop application 204 to activate the display 208. The desktop application 204 may be a non-universal platform application in some examples. In some examples, the display 208 may include a wall projection system, a screen mounted onto one or more walls within the meeting room, an interactive floor display, an interactive window display, or an interactive wall display, among other examples. The desktop application 204 may be included in a universal platform meeting management application package 210 together with the universal platform meeting management application 202.

According to additional examples, the universal platform meeting management application 202 and/or the desktop application 204 may be executed on a server 214. In further examples, the universal platform meeting management application 202 may be further configured to receive content to be presented in the meeting room (e.g., from one or more of the other computing devices 220), a communications input associated with audio data to be presented in the meeting room, and/or an input from the one or more sensors 222 based on the activity within the meeting room.

According to some examples, the universal platform meeting management application 202 may be further configured to detect another activity (e.g., an attendant entering the meeting room). In response, the universal platform meeting management application 202 may detect an inability to activate the display 208 in the meeting room due to a lack of application programming interfaces (APIs) 203 associated with the universal platform meeting management application 202. In further examples, the universal platform meeting management application 202 may be further configured to launch the desktop application 204. Additionally, the universal platform meeting management application 202 may be further configured to enable the desktop application 204 to activate the display 208 and may be further configured to enable the desktop application 204 to manage the display 208.

According to further examples, the desktop application 204 may be further configured to monitor the universal platform meeting management application 202. During the monitoring of the universal platform meeting management application 202, the universal platform meeting management application 202 may detect a crash of the universal platform meeting management application 202 and/or a deactivation of the universal platform meeting management application 202. In some examples, the crash of the universal platform meeting management application 202 may occur as a result of a software issue, a network issue, and/or a hardware issue associated with the computing device 212. In further examples, the desktop application 204 may be further configured to exit the universal platform meeting management application 202 and activate the display 208.

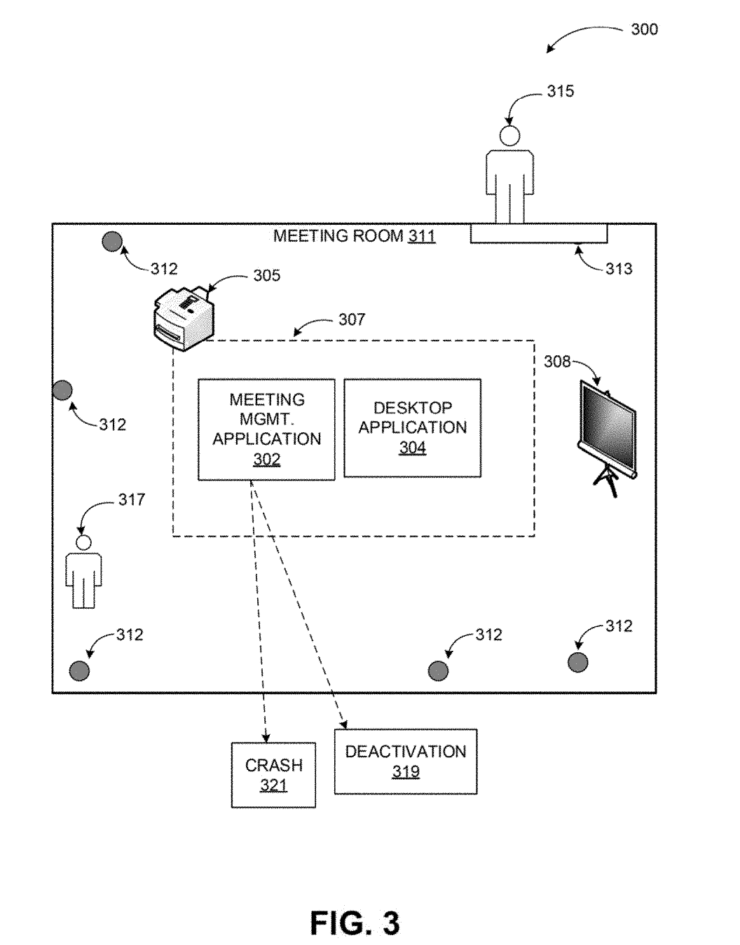

FIG. 3 illustrates a conceptual diagram of an example process to manage display settings based on motion sensor activity for universal platform applications, according to at least some embodiments disclosed herein.

As shown in a diagram 300, a computing device 305 (e.g., a special purpose computing device) may include a communication interface, one or more sensors 312, a memory, and/or a processor, among other components. The communication interface may be configured to facilitate exchange of data with other computing devices. The one or more sensors 312 may be configured to detect an activity 315 within a meeting room 311. In some examples, the activity 315 within the meeting room 311 may include movement of participants attending a meeting within the meeting room 311 and/or speech by the participants attending the meeting within the meeting room 311.

The one or more sensors 312 may include motion sensors, audio sensors, infrared sensors (e.g., infrared light-emitting diode (LED) sensors and/or passive infrared (PIR) sensors, among others), heat sensors, pressure sensors, and/or mechanical sensors, among others. In some examples, the motion sensors may detect movement by meeting participants/meeting attendants within the meeting room 311. In some examples, the audio sensors may include one or more microphones. The audio sensors may be configured to convert detected audio/sound into an electrical signal. In some examples, the audio sensors may analyze and perform processes on the detected audio/sound, such as speech recognition and/or Voice over Internet Protocol (VoIP), among other processes.

In further examples, infrared sensors, such as the passive infrared sensors, may be electrical sensors configured to measure infrared light radiating form objects within a field of view of the passive infrared sensors. In some examples, the passive infrared sensors may be used in PIR-based motion detectors. As such, the passive infrared sensors may be configured to detect motion within the meeting room 311.

In further examples, the pressure sensors may be configured to determine the number of meeting attendants/participants sitting within the meeting room 311, standing within the meeting room 311, and/or walking around the meeting room 311, etc. In some examples, the mechanical sensors may be configured to detect one or more of: an opening of a door to the meeting room 311, a closing of the door to the meeting room 311, the opening of a window to the meeting room 311, and/or the closing of the window to the meeting room 311, among other examples.

The memory may be configured to store instructions. The processor may be coupled to the communication interface, the one or more sensors 312, and/or the memory, among other components. In some examples, the processor may include a universal platform meeting management application 302. The universal platform meeting management application 302 may be configured to perform actions associated with managing presentations within the meeting room 311, managing communications (e.g., audio and video) within the meeting room 311, and controls associated with the meeting room 311. The actions may include, among others, recording audio associated with the meeting (e.g., speech of meeting attendants), recording video associated with the meeting (e.g., a presentation given during the meeting), modifying audio controls associated with speech of the meeting attendants during the meeting, modifying video controls associated with the meeting, managing online attendants to the meeting, and managing presented content associated with the meeting, among others.

In further examples, the universal platform meeting management application 302 may be further configured to register the activity 315 from the one or more sensors 312, indicating a need to activate a display 308 in the meeting room 311. The display 308 may include a wall projection system, a screen mounted onto one or more walls within the meeting room, an interactive floor display, an interactive window display, or an interactive wall display, among other examples. Further, the universal platform meeting management application 302 may be configured to activate a desktop application 304 configured to manage the display 308. The desktop application 304 may be included in a universal platform meeting management application package 307 together with the universal platform meeting management application 302.

According to further examples, the universal platform meeting management application 302 may be further configured to receive content to be presented from another computing device (e.g., another presentation and/or modifications to the content being presented), a communications input from the other computing device (e.g., an audio input, a graphical input, and/or a textual input, etc.), and/or additional data (e.g., additional audio data, movement data, and/or video data) from the other computing device.

According to some examples, the universal platform meeting management application 302 may be further configured to detect another activity 317 within the meeting room 311. In some examples, the universal platform meeting management application 302 may be further configured to detect an inability to activate the display 308 in the meeting room 311 due to a lack of application programming interfaces (APIs) associated with the universal platform meeting management application. In response, the universal platform meeting management application 302 may be further configured to launch the desktop application 304, enable the desktop application 304 to activate the display 308, and enable the desktop application 304 to manage the display 308.

According to further examples, in response to a detection, by the one or more sensors 312, of the display 308 exceeding a predefined period of inactivity, the universal platform meeting management application 302 may be further configured to turn off the display 308. Then, the universal platform meeting management application 302 may be further configured to detect another activity 317 from the one or more sensors 312 in the meeting room 311. The universal platform meeting management application 302 may then enable the desktop application 304 to activate the display 308. The other activity 317 may include, for example, a meeting attendant entering the meeting room 311 through a doorway 313 or the meeting attendant existing the meeting room 311, among others.

In some examples, a minimum duration period between a first launching of the universal platform meeting management application 302 and a second launching of the universal platform meeting management application 302 may be defined. The minimum duration period may include a timing period and may be measured in one or more of months, days, hours, minutes, or seconds, among other forms of measurement. The minimum duration period may be defined to avoid frequent launches of the universal platform meeting management application 302 due to a continued issue (e.g., a software issue, a network issue, or a hardware issue, among other examples) that causes the universal platform meeting management application 302 to crash 321. In other examples, the universal platform meeting management application 302 may become deactivated 319. The first launching and the second launching of the universal platform meeting management application 302 may be successive launchings.

According to further examples, one or more messages may be displayed in real-time on the display 308 in response to detecting the exit of the universal platform meeting management application 302. A textual scheme, a graphical scheme, an audio scheme, an animation scheme, a coloring scheme, a highlighting scheme, and/or a shading scheme may be employed to further enhance user interaction with a client interface of the universal platform meeting management application 302 or a universal platform meeting management service. In some examples, the one or more messages may prompt meeting attendants to provide user-definable input into the one or more messages.

The examples provided in FIG. 1 through FIG. 3 are illustrated with specific systems, services, applications, modules, and notifications. Embodiments are not limited to environments according to these examples. Embodiments to manage display settings based on motion sensor activity for universal platform applications may be implemented in environments employing fewer or additional systems, services, applications, engines, modules, and notifications. Furthermore, the example systems, services, applications, engines, modules, and notifications shown in FIG. 1 through FIG. 3 may be implemented in a similar manner with other values using the principles described herein.

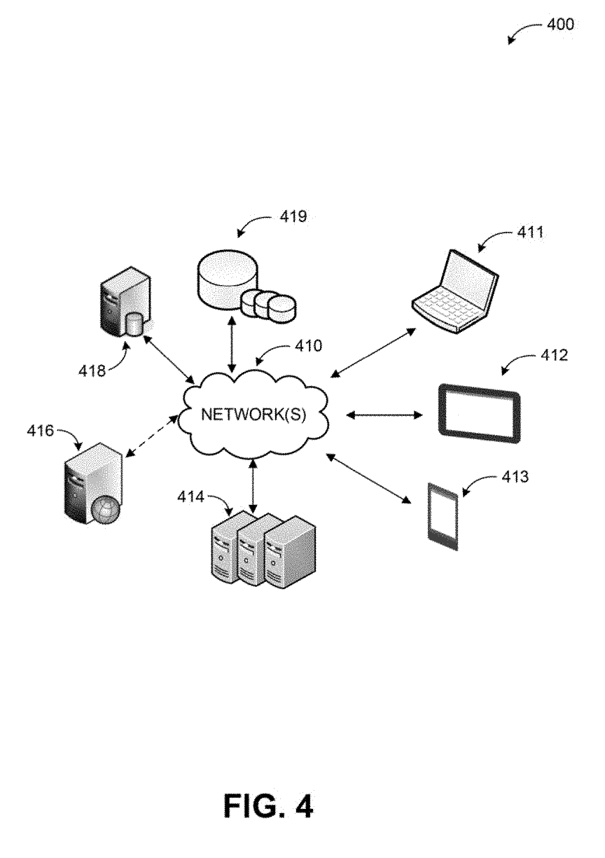

FIG. 4 is a networked environment, where a system according to embodiments may be implemented.

As shown in a diagram 400, a conference room management service or a universal platform meeting management service may be configured to manage display settings based on motion sensor activity for universal platform applications. The conference room management service or the universal platform meeting management service may be implemented in a networked environment over one or more networks, such as a network 410. Participants may access the conference room management service or the universal platform meeting management service through locally installed client applications or thin (e.g., browser-based) client applications executed on a variety of computing/client devices (e.g., a laptop 411, a tablet 412, and/or a smartphone 413, etc.). Functionality within the conference room management service or the universal platform meeting management service may be provided by a communication module or a communication application executed within the conference room management service or the universal platform meeting management service executed on servers 414 or processing server 416.

The conference room management service or the universal platform meeting management service, as discussed herein, may be implemented via software executed over servers 414. The servers 414, may include one or more processing server 416, where at least one of the one or more processing servers 416 may be configured to execute one or more applications associated with the conference room management service or the universal platform meeting management service. The conference room management service or the universal platform meeting management service may store data associated with a meeting 115 in a data store 419 directly or through a database server 418.

The network 410 may comprise any topology of servers, clients, Internet service providers, and communication media. A system according to embodiments may have a static or dynamic topology. The network 410 may include multiple secure networks, such as an enterprise network, an unsecure network, or the Internet. The unsecure network may include a wireless open network. The network 410 may also coordinate communication over other networks, such as Public Switched Telephone Network (PSTN) or cellular networks. Furthermore, the network 410 may include multiple short-range wireless networks, such as Bluetooth, or similar ones. The network 410 may provide communication between the nodes described herein. By way of example, and not limitation, the network 410 may include wireless media. The wireless media may include, among others, acoustic media, RF media, infrared media, and other wireless media.

Many other configurations of computing devices, applications, engines, modules, data sources, and data distribution systems may be employed to manage display settings based on motion sensor activity for universal platform applications. Furthermore, the networked environments discussed in FIG. 4 are for illustration purposes only. Embodiments are not limited to the example applications, modules, engines, or processes.

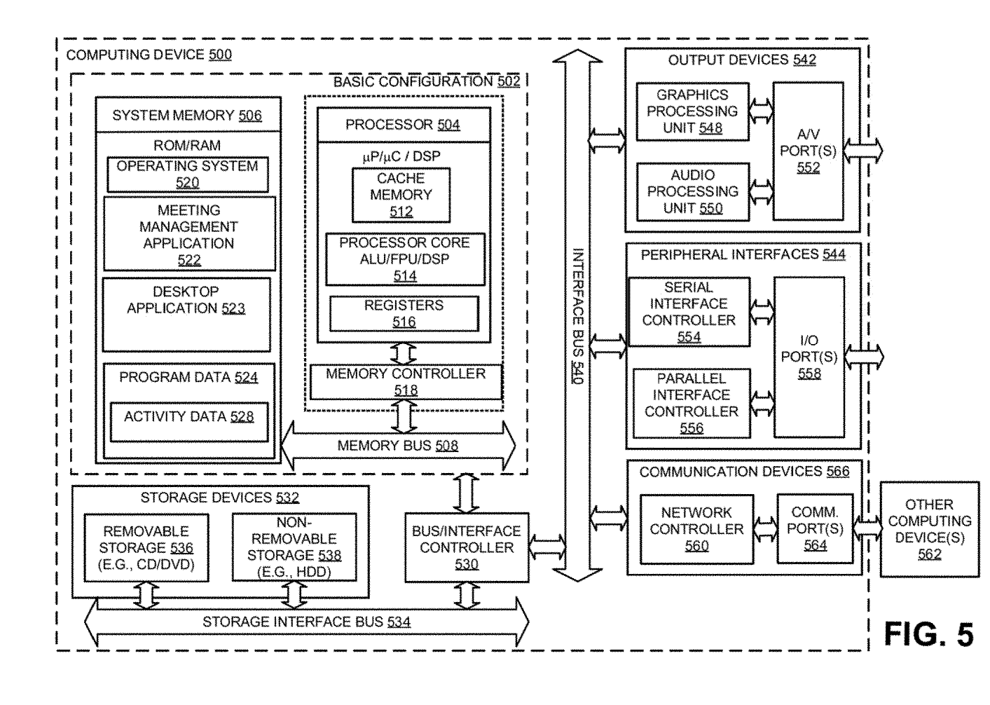

FIG. 5 is a block diagram of an example general purpose computing device, which may be used to manage display settings based on motion sensor activity for universal platform applications, according to at least some embodiments described herein.

For example, a computing device 500 may be used as a server, a desktop computer, a portable computer, a smart phone, a special purpose computer, or a similar device. In an example basic configuration 502, the computing device 500 may include one or more processors 504 and a system memory 506. A memory bus 508 may be used for communicating between the processor 504 and the system memory 506. The example basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof. The processor 504 may include one more levels of caching, such as a level cache memory 512, one or more processor cores 514, and registers 516. The one or more processor cores 514 may (each) include an arithmetic logic unit (ALU), a floating point unit (FPU), a digital signal processing core (DSP Core), or any combination thereof. An example memory controller 518 may also be used with the processor 504, or in some implementations the example memory controller 518 may be an internal part of the processor 504.

Depending on the desired configuration, the system memory 506 may be of any type including but not limited to volatile memory (such as RAM) and non-volatile memory (such as ROM, flash memory, etc.), or any combination thereof. The system memory 506 may include an operating system 520, a universal platform meeting management application 522, a desktop application 523, and program data 524. The universal platform meeting management application 522 may be configured register activity from one or more sensors indicating a need to activate a display in the meeting room. The universal platform meeting management application 522 may then be configured to activate the desktop application 523 configured to manage the display and may enable the desktop application 523 to activate the display. The desktop application 523 may be included in a universal platform meeting management application package together with the universal platform meeting management application 522. The program data 524 may include activity data 528 (e.g., audio data, visual data, and/or movement data) associated with meeting attendants within the meeting room. The program data 524 may also include additional data (e.g., additional audio data, additional visual data, and/or additional movement data) received from one or more other computing devices.

The computing device 500 may have additional features or functionality, and additional interfaces to facilitate communications between the example basic configuration 502 and any desired devices and interfaces. For example, a bus/interface controller 530 may be used to facilitate communications between the example basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (for example, one or more output devices 542, one or more peripheral interfaces 544, and an example communication device 546) to the example basic configuration 502 via the bus/interface controller 530. Some of the one or more output devices 542 may include a graphics processing unit 548 and an audio processing unit 550, which may be configured to communicate with various external devices, such as a display or speakers via one or more A/V ports 552. The one or more peripheral interfaces 544 may include a serial interface controller 554 or a parallel interface controller 556, which may be configured to communicate with external devices, such as input devices (e.g., a keyboard, a mouse, a pen, a voice input device, and/or a touch input device, etc.) or other peripheral devices (e.g., a printer and/or a scanner, etc.) via one or more I/O ports 558. The example communication device 546 may include a network controller 560, which may be arranged to facilitate communications with one or more other computing devices 562 over a network communication link via one or more communication ports 564. The one or more other computing devices 562 may include servers, computing devices, and comparable devices.

The network communication link may be one example of a communication media. The communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, the communication media may include wired media such as a wired network or direct-wired connection, and wireless media such as acoustic, radio frequency (RF), microwave, infrared (IR) and other wireless media. The term computer readable media, as used herein, may include both storage media and communication media.

The computing device 500 may be implemented as a part of a general purpose or a specialized server, a mainframe, or similar computer that includes any of the above functions. The computing device 500 may also be implemented as a personal computer, including both laptop computer configurations and non-laptop computer configurations.

Example embodiments may also include methods to manage display settings based on motion sensor activity for universal platform applications. These methods can be implemented in any number of ways, including the structures described herein. One such way may be by machine operations of devices of the type described in the present disclosure. Another optional way may be for one or more of the individual operations of the methods to be performed in conjunction with one or more human operators performing some of the operations while other operations may be performed by machines. These human operators need not be co-located with each other, but each can be only with a machine that performs a portion of the program. In other embodiments, the human interaction can be automated such as by pre-selected criteria that may be machine automated.

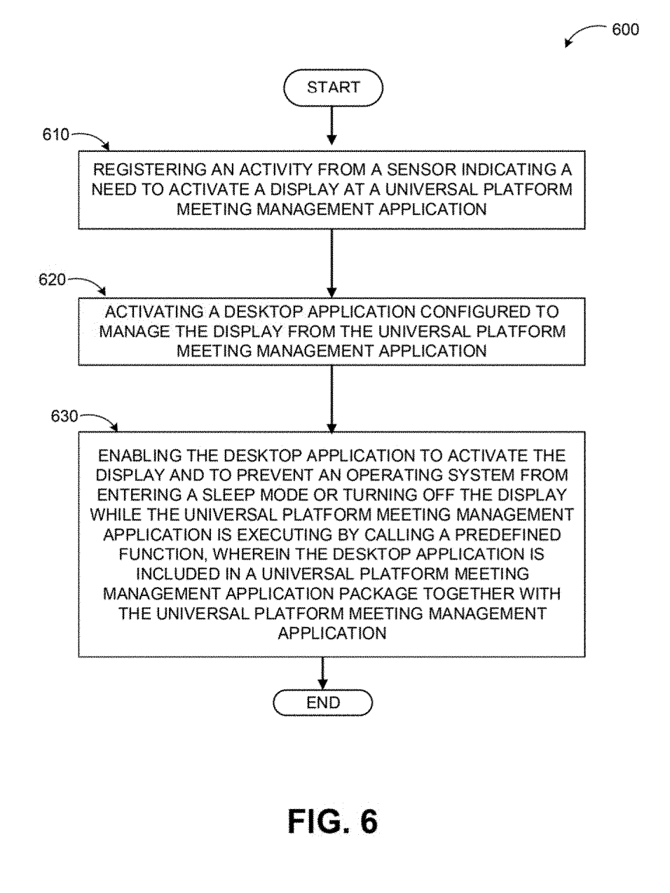

FIG. 6 includes a logic flow diagram that illustrates a process to manage display settings based on motion sensor activity for universal platform applications, according to at least some embodiments disclosed herein.

Process 600 may be implemented on a computing device, a server, or another system. An example computing device may include a communication interface, one or more sensors, a memory, and a processor. The communication interface may be configured to facilitate an exchange of data with other computing devices. The one or more sensors may be configured to detect an activity within a meeting room. The memory may be configured to store instructions. The processor may be coupled to the communication interface, the one or more sensors, and/or the memory, among other components.

Process 600 begins with operation 610, where the universal platform meeting management application may be configured to register an activity from the one or more sensors indicating a need to activate a display at a universal platform meeting management application in the meeting room. In some examples, the sensors may include motion sensors, heat sensors, pressure sensors, and/or mechanical sensors, among others. In further examples, the mechanical sensors may be configured to detect an opening of a door to the meeting room, a closing of the door to the meeting room, the opening of a window to the meeting room, and/or the closing of the window to the meeting room, among other examples.

Operation 610 may be followed by operation 620, where the universal platform meeting management application may be further configured to activate a desktop application configured to manage the display. According to further examples, the desktop application may be configured to monitor the universal platform meeting management application, detect a crash of the universal platform meeting management application and/or a deactivation of the universal platform meeting management application, exit the universal platform meeting management application, and activate the display.

Operation 620 may be followed by operation 630, where the universal platform meeting management application may be further configured to enable the desktop application to activate the display and to prevent an operating system from entering a sleep mode or turning off the display while the universal platform meeting management application is executing by calling a predefined function. The desktop application may be included in a universal platform meeting management application package together with the universal platform meeting management application. In additional examples, the universal platform meeting management application and the desktop application may be executed on a server. In further examples, the universal platform meeting management application may be further configured to receive content to be presented in the meeting room, a communications input associated with audio data to be presented in the meeting room, and/or an input from the sensor based on the activity within the meeting room.

In further examples, the universal platform meeting management application may be further configured to detect another activity within the meeting room, detect an inability to activate the display in the meeting room due to a lack of application programming interfaces (APIs) associated with the universal platform meeting management application, launch the desktop application, enable the desktop application to activate the display, and enable the desktop application to manage the display.

The operations included in process 600 are for illustration purposes. Managing display settings based on motion sensor activity for universal platform applications may be implemented by similar processes with fewer or additional steps, as well as in a different order of operations using the principles described herein. The operations described herein may be executed by one or more processors operated on one or more computing devices, one or more processor cores, specialized processing devices, and/or general purpose processors, among other examples.

According to some examples, a means for managing display settings based on motion sensor activity for universal platform applications may be described, which may include a means for registering an activity from a sensor indicating a need to activate a display at a universal platform meeting management application in a meeting room, a means for activating a desktop application configured to manage the display from the universal platform meeting management application, and a means for enabling the desktop application to activate the display and to prevent an operating system from entering a sleep mode or turning off the display while the universal platform meeting management application is executing by calling a predefined function. The desktop application may be included in a universal platform meeting management application package together with the universal platform meeting management application.

According to further examples, an example method may be executed on a computing device for managing display settings based on motion sensor activity for universal platform applications. The example method may include process steps, such as, registering an activity from a sensor indicating a need to activate a display at a universal platform meeting management application in a meeting room, activating a desktop application configured to manage the display from the universal platform meeting management application, and enabling the desktop application to activate the display and to prevent an operating system from entering a sleep mode or turning off the display while the universal platform meeting management application is executing by calling a predefined function. The desktop application may be included in a universal platform meeting management application package together with the universal platform meeting management application.

According to additional examples, in response to a detection of the display exceeding a predefined period of inactivity, the example method may further include turning off the display. The example method may additionally include detecting another activity from the sensor in the meeting room and enabling the desktop application to activate the display. In some examples, the other activity may include a participant entering the meeting room. In other examples, the other activity may include a meeting being scheduled in the meeting room within a predefined time period.

According to further examples, the sensor may include a motion sensor, a heat sensor, a pressure sensor, and/or a mechanical sensor. In additional examples, the mechanical sensor may be configured to detect an opening of a door to the meeting room, a closing of the door to the meeting room, the opening of a window to the meeting room, and/or the closing of the window to the meeting room. According to some additional examples, the example method may further include registering the activity from the sensor upon a launch of the universal platform meeting management application. According to some examples, the example method may include performing, by the universal platform meeting management application, actions that include recording a meeting, managing audio controls during the meeting, managing video controls during the meeting, managing online attendants during the meeting, and/or managing presented content during the meeting.

According to other examples, a computing device may be configured to manage display settings based on motion sensor activity for universal platform applications. The computing device may include a communication interface, sensors, a memory, and a processor, among other components. The communication interface may be configured to facilitate exchange of data with other computing devices. The sensors may be configured to detect an activity within a meeting room. The memory may be configured to store instructions. The processor may be coupled to the communication interface, the sensors, and the memory. The processor may include a universal platform meeting management application. The universal platform meeting management application may be configured to register the activity from the sensors indicating a need to activate a display in the meeting room, activate a desktop application configured to manage the display, and enable the desktop application to activate the display and to prevent an operating system from entering a sleep mode or turning off the display while the universal platform meeting management application is executing by calling a predefined function. The desktop application may be included in a universal platform meeting management application package together with the universal platform meeting management application.

According to additional examples, the universal platform meeting management application and the desktop application may be executed on a server. According to some examples, the universal platform meeting management application may be further configured to receive content to be presented in the meeting room, a communications input associated with audio data to be presented in the meeting room, and/or an input from the sensor based on the activity within the meeting room. According to additional examples, the universal platform meeting management application may be further configured to detect another activity within the meeting room and detect an inability to activate the display in the meeting room due to a lack of application programming interfaces (APIs) associated with the universal platform meeting management application. According to some examples, the universal platform meeting management application may be further configured to launch the desktop application. The desktop application may be configured to activate and manage the display.

According to further examples, the desktop application may be further configured to monitor the universal platform meeting management application and detect a crash of the universal platform meeting management application and/or a deactivation of the universal platform meeting management application. According to some examples, the desktop application may be further configured to exit the universal platform meeting management application, activate the display, and display messages in real-time on the display to inform a participant of the exit of the universal platform meeting management application.

According to further examples, a computer-readable memory device with instructions stored thereon to manage display settings based on motion sensor activity for universal platform applications may be described. The instructions may include registering an activity from a sensor indicating a need to activate a display at a universal platform meeting management application in a meeting room, activating a desktop application configured to manage the display from the universal platform meeting management application, and enabling the desktop application to activate the display and to prevent an operating system from entering a sleep mode or turning off the display while the universal platform meeting management application is executing by calling a predefined function. The desktop application may be included in a universal platform meeting management application package together with the universal platform meeting management application.

According to some examples, in response to a detection of the display exceeding a predefined period of inactivity, the instructions may further include turning off the display. In additional examples, the instructions may further include detecting another activity from the sensor in the meeting room. The other activity may include a participant entering the meeting room. The instructions may further include enabling the desktop application to activate the display. In further examples, the sensor may include a motion sensor, a heat sensor, a pressure sensor, and/or a mechanical sensor. In additional examples, the mechanical sensor may be configured to detect an opening of a door to the meeting room, a closing of the door to the meeting room, the opening of a window to the meeting room, and/or the closing of the window to the meeting room. According to some examples, the instructions may further include enabling the universal platform meeting management application to perform processes, such as recording a meeting, managing audio controls during the meeting, managing video controls during the meeting, managing online attendants during the meeting, and/or managing presented content during the meeting.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for managing display settings based on motion sensor activity for universal platform applications, the method comprising:
registering an activity from a sensor indicating a need to activate a display at a universal platform meeting management application in a meeting room;
activating a desktop application configured to manage the display from the universal platform meeting management application; and
enabling the desktop application to activate the display and to prevent an operating system from entering a sleep mode or turning off the display while the universal platform meeting management application is executing by calling a predefined function, wherein the desktop application is included in a universal platform meeting management application package together with the universal platform meeting management application.

2. The method of claim 1, further comprising:
in response to a detection of the display exceeding a predefined period of inactivity, turning off the display;
detecting another activity from the sensor in the meeting room; and
enabling the desktop application to activate the display.

3. The method of claim 2, wherein the other activity includes a participant entering the meeting room.

4. The method of claim 2, wherein the other activity includes a meeting being scheduled in the meeting room within a predefined time period.

5. The method of claim 1, wherein the sensor includes one or more of: a motion sensor, a heat sensor, a pressure sensor, and a mechanical sensor.

6. The method of claim 5, wherein the mechanical sensor is configured to detect one or more of: an opening of a door to the meeting room, a closing of the door to the meeting room, the opening of a window to the meeting room, and the closing of the window to the meeting room.

7. The method of claim 1, further comprising:
registering the activity from the sensor upon a launch of the universal platform meeting management application.

8. The method of claim 1, further comprising:
performing, by the universal platform meeting management application, one or more actions that include recording a meeting, managing audio controls during the meeting, managing video controls during the meeting, managing online attendants during the meeting, and managing presented content during the meeting.

9. A computing device configured to manage display settings based on motion sensor activity for universal platform applications, the computing device comprising:
a communication interface configured to facilitate exchange of data with other computing devices;
one or more sensors configured to detect an activity within a meeting room;
a memory configured to store instructions; and
a processor coupled to the communication interface, the one or more sensors, and the memory, wherein the processor includes:
a universal platform meeting management application configured to:
register the activity from the one or more sensors indicating a need to activate a display in the meeting room;
activate a desktop application configured to manage the display; and
enable the desktop application to activate the display and to prevent an operating system from entering a sleep mode or turning off the display while the universal platform meeting management application is executing by calling a predefined function, wherein the desktop application is included in a universal platform meeting management application package together with the universal platform meeting management application.

10. The computing device of claim 9, wherein the universal platform meeting management application and the desktop application are executed on a server.

11. The computing device of claim 9, wherein the universal platform meeting management application is further configured to:
receive one or more of: content to be presented in the meeting room, a communications input associated with audio data to be presented in the meeting room, and an input from the sensor based on the activity within the meeting room.

12. The computing device of claim 9, wherein the universal platform meeting management application is further configured to:
detect another activity within the meeting room; and
detect an inability to activate the display in the meeting room due to a lack of application programming interfaces (APIs) associated with the universal platform meeting management application.

13. The computing device of claim 12, wherein the universal platform meeting management application is further configured to:
launch the desktop application, wherein the desktop application is configured to activate and manage the display.

14. The computing device of claim 9, wherein the desktop application is further configured to:
monitor the universal platform meeting management application; and
detect one or more of a crash of the universal platform meeting management application and a deactivation of the universal platform meeting management application.

15. The computing device of claim 14, wherein the desktop application is further configured to:
exit the universal platform meeting management application; and
activate the display.

16. The computing device of claim 15, wherein the desktop application is further configured to:
display one or more messages in real-time on the display to inform a participant of the exit of the universal platform meeting management application.

17. A computer-readable memory device with instructions stored thereon to manage display settings based on motion sensor activity for universal platform applications, the instructions comprising:
registering an activity from a sensor indicating a need to activate a display at a universal platform meeting management application in a meeting room;
activating a desktop application configured to manage the display from the universal platform meeting management application; and
enabling the desktop application to activate the display and to prevent an operating system from entering a sleep mode or turning off the display while the universal platform meeting management application is executing by calling a predefined function, wherein the desktop application is included in a universal platform meeting management application package together with the universal platform meeting management application.

18. The computer-readable memory device of claim 17, wherein the instructions further comprise:
in response to a detection of the display exceeding a predefined period of inactivity, turning off the display;
detecting another activity from the sensor in the meeting room, wherein the other activity includes a participant entering the meeting room; and
enabling the desktop application to activate the display.

19. The computer-readable memory device of claim 17, wherein:
the sensor includes one or more of: a motion sensor, a heat sensor, a pressure sensor, and a mechanical sensor, and
the mechanical sensor is configured to detect one or more of: an opening of a door to the meeting room, a closing of the door to the meeting room, the opening of a window to the meeting room, and the closing of the window to the meeting room.

20. The computer-readable memory device of claim 17, wherein the instructions further comprise:
enabling the universal platform meeting management application to perform one or more of: record a meeting, manage audio controls during the meeting, manage video controls during the meeting, manage online attendants during the meeting, and manage presented content during the meeting.
